(19) United States
(12) Patent Application Publication
(10) Pub. No.: US 2021/0370924 A1
(43) Pub. Date: Dec. 2, 2021

(54) DRIVING ASSISTANCE APPARATUS

(71) Applicant: TOYOTA JIDOSHA KABUSHIKI KAISHA, Toyota-shi (JP)

(72) Inventors: Takahiro KUNO, Susono-shi (JP); Naoki OKADA, Susono-shi (JP); Tasuku USUI, Gotenba-shi (JP)

(21) Appl. No.: 17/224,241

(22) Filed: Apr. 7, 2021

(30) Foreign Application Priority Data
May 26, 2020 (JP) 2020-091555

(51) Int. Cl. B60W 30/09; B60W 30/095; B60W 30/18; B60W 40/105; B60W 10/18; B60T 7/22

(52) U.S. Cl. CPC B60W 30/09; B60W 30/0956; B60W 30/18109; B60W 40/105; B60W 10/18; B60T 2201/022; B60W 2510/18; B60W 2554/4029; B60W 2554/802; B60W 2554/804; B60T 7/22

(57) ABSTRACT

A driving assistance apparatus is configured to identify a target as a crossing target when a vehicle and the target are expected to collide with each other in an intersecting region, configured to decelerate the vehicle at a first deceleration from a first timing before an expected collision timing that the vehicle and the crossing target are expected to collide with each other, and configured to decelerate the vehicle at a second deceleration from a second timing when the crossing target is still present at a second timing immediately before a third timing defined such that the vehicle is not stoppable at a position immediately before entering the intersecting region in a case where the vehicle starts to decelerate from the third timing at a second deceleration having an absolute value larger than an absolute value of the first deceleration.

### CROSS-REFERENCE TO RELATED APPLICATION

This application claims priority to Japanese Patent Application No. 2020-091555 filed on May 26, 2020, incorporated herein by reference in its entirety.

### BACKGROUND

### 1. Technical Field

The present disclosure relates to a driving assistance apparatus. For example, the driving assistance apparatus is used for avoiding collision between a vehicle and a target by decelerating the vehicle with a braking force when there is a strong possibility of the collision.

### 2. Description of Related Art

There is disclosed a driving assistance apparatus configured to decelerate a vehicle by automatically generating a braking force to avoid collision between the vehicle and an object present in an expected traveling region of the vehicle (for example, another vehicle parked in a lane of the vehicle) (see, for example, Japanese Unexamined Patent Application Publication No. 2017-114427 (JP 2017-114427 A)). The vehicle including the driving assistance apparatus may hereinafter be referred to also as “driver's vehicle” for convenience to distinguish the vehicle from the other vehicle. The expected traveling region of the driver's vehicle is referred to also as “driver's vehicle passing region”.

More specifically, the driving assistance apparatus selectively executes high-G braking control (“G” represents a gravitational force equivalent) for decelerating the driver's vehicle with a great braking force, and low-G braking control for decelerating the driver's vehicle with a relatively small braking force. When the degree of overlap between the driver's vehicle and a target present in the driver's vehicle passing region is relatively low, the driving assistance apparatus first executes the low-G braking control. When the driver does not perform a turning operation (steering operation) during execution of the low-G braking control and, as a result, there is a strong possibility that collision with the target cannot be avoided even if the low-G braking control is continued, the driving assistance apparatus executes the high-G braking control.

Thus, the driving assistance apparatus can reduce a possibility that the high-G braking control is executed when the driver intends to avoid collision through the turning operation, and can therefore reduce a possibility that the driver feels extreme discomfort with unnecessary high-G braking.

### SUMMARY

Also when the driver's vehicle has a strong possibility of colliding with a target approaching the driver's vehicle passing region (for example, another vehicle that may cross a region ahead of the driver's vehicle), the driving assistance apparatus desirably applies a braking force to the driver's vehicle to avoid the collision. The target approaching to cross the driver's vehicle passing region is hereinafter referred to also as “candidate target”.

The other vehicle that is the candidate target may apply a brake to avoid the collision with the driver's vehicle, and therefore stop before the other vehicle reaches the driver's vehicle passing region. If the driving assistance apparatus sharply decelerates the driver's vehicle with a great braking force though the collision does not occur, the driver of the driver's vehicle may feel extreme discomfort. The braking using a great braking force generated to avoid collision though the collision does not actually occur is hereinafter referred to also as “unnecessary strong braking”.

The present disclosure provides a driving assistance apparatus that can avoid collision between a driver's vehicle and a candidate target and can reduce a possibility of occurrence of unnecessary strong braking for the candidate target.

A first aspect of the present disclosure relates to a driving assistance apparatus. The driving assistance apparatus includes a target detecting device, a braking device, and a controller. The target detecting device is configured to detect a target approaching a vehicle passing region to cross the vehicle passing region. The vehicle passing region is a region where a vehicle is expected to travel. The braking device is configured to generate a braking force in the vehicle. The controller is configured to control the braking device. The controller is configured to identify the target as a crossing target and control the braking device to decelerate the vehicle at a first deceleration from a first timing before an expected collision timing that the vehicle and the crossing target are expected to collide with each other, when the vehicle keeps a current vehicle speed, the target keeps a current target speed, and the vehicle and the target are expected to collide with each other in an intersecting region where the vehicle passing region and a target passing region overlap each other. The target passing region is a region where the target is expected to pass. The controller is configured to control the braking device to decelerate the vehicle at a second deceleration from a second timing when the crossing target is still present at a second timing immediately before a third timing. The third timing is a timing succeeding the first timing, defined such that the vehicle is being decelerated at the first deceleration, and defined such that the vehicle is not stoppable at a position immediately before entering the intersecting region when the vehicle starts to decelerate from the third timing at a second deceleration having an absolute value larger than an absolute value of the first deceleration.

In the first aspect, when the candidate target is identified as the crossing target, the vehicle starts to decelerate relatively gently from the first timing before the expected collision timing. When the candidate target does not decelerate before the second timing arrives and the candidate target is still identified as the crossing target at the second timing, the vehicle starts to sharply decelerate from the second timing so that the vehicle is stopped at a position immediately before reaching the intersecting region. Thus, even if the target identified as the crossing target does not decelerate, the collision between the vehicle and the crossing target can be avoided. The vehicle does not sharply decelerate when the target identified as the crossing target starts to decelerate in a period from the first timing to the second timing and, as a result, “target is expected not to enter intersecting region” at the second timing (that is, the target is no longer identified as the crossing target).

Thus, the vehicle does not sharply decelerate when the target identified as the crossing target decelerates and does not enter the intersecting region (that is, when the collision does not occur). According to the first aspect, it is possible to reduce the possibility of occurrence of the unnecessary strong braking, and therefore to reduce the possibility of the driver's extreme discomfort.

In the first aspect, the controller may be configured to acquire, as the second timing, a target braking necessary timing immediately before a fourth timing. The fourth timing may be defined such that the crossing target starts to decelerate at a predetermined expected target deceleration. The fourth timing may be defined that the crossing target is not stoppable at a position immediately before entering the intersecting region when the crossing target continues to decelerate at the expected target deceleration.

In the configuration described above, the timing having a strong probability that the crossing target cannot be stopped immediately before entering the intersecting region even though the crossing target starts to decelerate at the expected target deceleration is used as the second timing. According to this configuration, it is possible to effectively reduce the possibility of occurrence of the unnecessary strong braking, and to avoid the collision between the crossing target and the vehicle.

In the first aspect, the controller may be configured to control the braking device to decelerate the vehicle at the second deceleration from a high-G braking start timing without decelerating the vehicle at the first deceleration from the first timing, when the target braking necessary timing is predicted to arrive before the high-G braking start timing. The high-G braking start timing may be a timing immediately before a fifth timing that the vehicle starts to decelerate at the second deceleration. The fifth timing may be a timing defined such that the vehicle continues to decelerate at the second deceleration and the vehicle is not stoppable at a position immediately before entering the intersecting region.

When the target braking necessary timing is earlier than the high-G braking start timing, determination can be made that “crossing target has extremely strong possibility of entering intersecting region” at the high-G braking start timing. In the configuration described above, even if the vehicle starts to decelerate at the second deceleration from the high-G braking start timing, the braking is not the unnecessary strong braking.

In the first aspect, the controller may be configured to acquire “type” of the crossing target, and change the expected target deceleration depending on the acquired type.

Examples of the type of the crossing target include other vehicles and targets different from the other vehicles. The other vehicles may further include an ordinary-sized automobile, a large-sized vehicle, and a motorcycle. The targets different from the other vehicles may further include a pedestrian. According to the configuration described above, the expected target deceleration can be set to an appropriate deceleration depending on the type of the crossing target. For example, the expected target deceleration is a typical deceleration of the crossing target to avoid collision between the crossing target and another vehicle (in this case, the vehicle including the apparatus of the present disclosure). According to this configuration, the target braking necessary timing can be determined accurately.

In the first aspect, the controller may be configured to acquire a type of the crossing target, and acquire, as the second timing, a timing that a distance between a pedestrian and the vehicle passing region is smaller than a predetermined distance threshold when the acquired type is the pedestrian.

In general, a period from the start of deceleration of the pedestrian to the stop of the pedestrian is much shorter than that of the vehicle. In other words, it is difficult to set the expected target deceleration of the pedestrian to a certain value, and the expected target deceleration may rather be infinite.

The pedestrian who is aware of approach of the vehicle generally stops at a position spaced away from the vehicle passing region of the vehicle by a predetermined allowance distance. Therefore, the distance threshold may be set to a distance that is based on the allowance distance. When the distance between the pedestrian and the vehicle passing region is smaller than the distance threshold, there is a strong possibility that the pedestrian is not aware of the approach of the vehicle. In the configuration described above, the timing when the distance between the pedestrian and the vehicle passing region is smaller than the distance threshold is used as the second timing. Thus, it is possible to avoid the collision with the pedestrian approaching the vehicle passing region, and to reduce the possibility of occurrence of the unnecessary strong braking for the pedestrian approaching the vehicle passing region.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a vehicle including a driving assistance apparatus (assistance apparatus) according to an embodiment of the present disclosure;

FIG. 2 is a block diagram of the assistance apparatus;

FIG. 3 is a diagram illustrating an example of a passing-region target that triggers first braking control;

FIG. 4 is a time chart illustrating changes in a traveling speed of the vehicle (vehicle speed), a deceleration of the vehicle, and a longitudinal target distance when the first braking control is executed;

FIG. 5 is a graph illustrating a relationship between the vehicle speed and a braking start time;

FIG. 6 is a diagram illustrating an example of a crossing target that triggers second braking control;

FIG. 7 is a time chart illustrating changes in the vehicle speed, a transverse target speed, the longitudinal target distance, and a transverse target distance when the second braking control is executed for the crossing target of FIG. 6;

FIG. 8 is a diagram illustrating another example of the crossing target that triggers the second braking control;

FIG. 9 is a time chart illustrating changes in the vehicle speed, the transverse target speed, the longitudinal target distance, and the transverse target distance when the second braking control is executed for the crossing target of FIG. 8;

FIG. 10 is a flowchart illustrating an automatic braking process routine to be executed by the assistance apparatus; and

FIG. 11 is a flowchart illustrating a longitudinal target braking distance acquisition process routine to be executed by the assistance apparatus.

### DETAILED DESCRIPTION OF EMBODIMENTS

Configuration

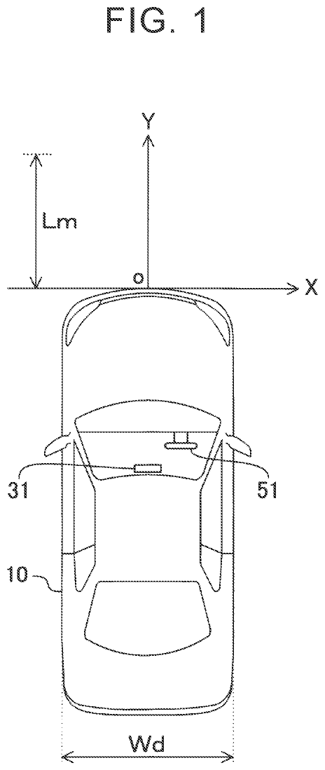

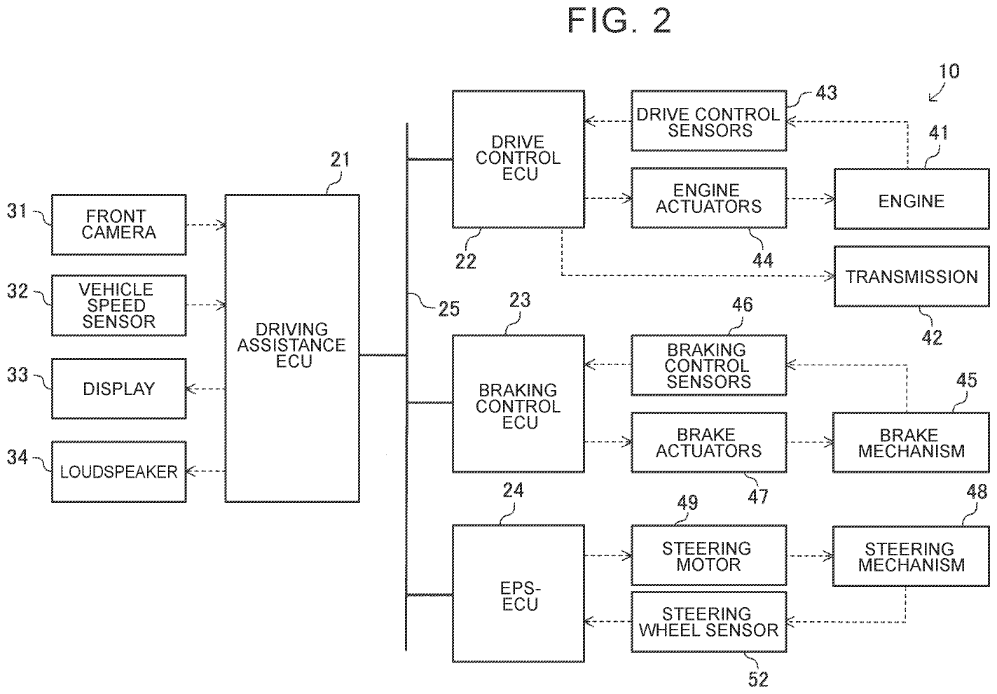

A driving assistance apparatus according to an embodiment of the present disclosure (hereinafter referred to also as “assistance apparatus”) is described below with reference to the drawings. The assistance apparatus is applied to a driver's vehicle 10 illustrated in FIG. 1. As understood from FIG. 2 that is a block diagram of the assistance apparatus, the assistance apparatus includes electronic control units (ECUs) that are “driving assistance ECU 21, drive control ECU 22, braking control ECU 23, and electrical power steering (EPS)-ECU 24”.

The driving assistance ECU 21 includes, as a main component, a microcomputer including a central processing unit (CPU), a non-volatile memory, and a random-access memory (RAM). The CPU sequentially executes predetermined programs (routines) to read data, calculate values, and output calculation results. The non-volatile memory includes a read-only memory (ROM) and a rewritable flash memory, and stores, for example, programs to be executed by the CPU and lookup tables (maps) to be referenced when the programs are executed. The RAM temporarily stores data to be referenced by the CPU.

The drive control ECU 22, the braking control ECU 23, and the EPS-ECU 24 include microcomputers as their main components similarly to the driving assistance ECU 21. Those ECUs can communicate (exchange) data via a controller area network (CAN) 25.

Each ECU can receive, from “other ECUs” via the CAN 25, output values from sensors connected to the other ECUs. For example, the drive control ECU 22, the braking control ECU 23, and the EPS-ECU 24 can receive, from the driving assistance ECU 21 via the CAN 25, a vehicle speed Vs detected by a vehicle speed sensor 32 described later that is connected to the driving assistance ECU 21. All or some of the ECUs may be integrated into a single ECU (control unit).

The driving assistance ECU 21 is hereinafter simply referred to also as “ECU 21”. The ECU 21 is connected to a front camera 31, the vehicle speed sensor 32, a display 33, and a loudspeaker 34.

The front camera 31 is arranged near a rear-view mirror (not illustrated) at the top in a vehicle cabin of the driver's vehicle 10 (see FIG. 1). The front camera 31 acquires “forward-view image” obtained by imaging a region ahead of the driver's vehicle 10 every time a predetermined time interval ΔTc (fixed value) has elapsed, and outputs a signal indicating the forward-view image to the ECU 21.

The vehicle speed sensor 32 detects the vehicle speed Vs that is a traveling speed of the driver's vehicle 10, and outputs a signal indicating the vehicle speed Vs to the ECU 21.

The display 33 is a liquid crystal display (LCD) arranged in the vehicle cabin of the driver's vehicle 10 at a position where the driver can view the display 33. Texts and graphical objects to be displayed on the display 33 are controlled by the ECU 21.

The loudspeaker 34 is arranged in the vehicle cabin of the driver's vehicle 10. Alert sounds and voice messages to be reproduced by the loudspeaker 34 are controlled by the ECU 21.

Driving Force Control

The drive control ECU 22 controls an engine 41 and a transmission 42 to adjust a driving force of the driver's vehicle 10. The drive control ECU 22 is connected to various drive control sensors 43, and receives output values from those sensors. The drive control sensors 43 detect operation condition amounts (parameters) of the engine 41 and driver's operations related to drive control.

The drive control sensors 43 include an accelerator pedal operation amount (depression amount) sensor, a shift position sensor configured to detect an operation status of a shift lever, a throttle valve opening degree sensor, an engine speed sensor, and an intake air amount sensor. The drive control ECU 22 determines a request driving torque Frq (request value of a driving torque Fd described later) based on, for example, the vehicle speed Vs and the output values from the drive control sensors 43.

The drive control ECU 22 is connected to engine actuators 44 including a throttle valve actuator and a fuel injection valve, and controls those actuators to control a torque to be generated by the engine 41. The drive control ECU 22 controls the engine actuators 44 and the transmission 42 so that the driving torque Fd to be transmitted to driving wheels of the driver's vehicle 10 is equal to the request driving torque Frq, thereby controlling an acceleration Ac that is a change amount of the vehicle speed Vs per unit time.

When the drive control ECU 22 receives “driving force control request” including a target driving torque Ftg from the ECU 21, the drive control ECU 22 controls the engine actuators 44 and the transmission 42 so that the actual driving torque Fd is equal to the target driving torque Ftg. When the drive control ECU 22 does not newly receive a driving force control request from the ECU 21 for a predetermined continuous period after the previous driving force control request is received, the drive control ECU 22 resumes the process for controlling the acceleration Ac so that the driving torque Fd is equal to the request driving torque Frq.

Braking Force Control

The braking control ECU 23 controls a brake mechanism 45 that is a hydraulic friction braking device (braking mechanism) mounted on the driver's vehicle 10. The braking control ECU 23 is connected to various braking control sensors 46, and receives output values from those sensors. The braking control sensors 46 detect condition amounts to be used for controlling the brake mechanism 45 and driver's operations related to braking control. The braking control sensors 46 include a brake pedal operation amount sensor and a pressure sensor for brake oil that works in the brake mechanism 45. The braking control ECU 23 determines a request braking force Brq (request value of a braking force Bf described later) based on, for example, the vehicle speed Vs and the output values from the braking control sensors 46.

The braking control ECU 23 is connected to various brake actuators 47 that are hydraulic control actuators for the brake mechanism 45. The braking control ECU 23 controls the brake actuators 47 so that the braking force Bf that is the total of friction braking forces to be generated by the wheels of the driver's vehicle 10 is equal to the request braking force Brq, thereby controlling the acceleration Ac. In this case, the acceleration Ac is a negative value. The magnitude of the acceleration Ac when the vehicle speed Vs is reduced through the operation of the brake mechanism 45 is hereinafter referred to also as “deceleration As”.

When the braking control ECU 23 receives “braking force control request” including a target deceleration Atg from the ECU 21, the braking control ECU 23 generates a braking force Bf by using the brake actuators 47 so that the actual deceleration As is equal to the target deceleration Atg. When the braking control ECU 23 does not newly receive a braking force control request from the ECU 21 for a predetermined continuous period after the previous braking force control request is received, the braking control ECU 23 resumes the process for controlling the deceleration As so that the braking force Bf is equal to the request braking force Brq. When the braking force Bf to be generated based on the target deceleration Atg is smaller than the request braking force Brq, the braking control ECU 23 controls the brake actuators 47 so that the actual braking force Bf is equal to the request braking force Brq.

Steered Angle Control

The EPS-ECU 24 controls a steering motor 49 connected to a steering mechanism 48 mounted on the driver's vehicle 10. The steering mechanism 48 includes a steering wheel 51 (see FIG. 1), and changes a steered angle θs of each steered wheel of the driver's vehicle 10 (that is, front wheel) based on a steering angle that is a rotation angle of the steering wheel 51.

The EPS-ECU 24 is connected to a steering wheel sensor 52, and receives an output value from the steering wheel sensor 52. The steering wheel sensor 52 detects a steering angle of the steering wheel 51 and a steering torque applied to a steering shaft coupled to the steering wheel 51.

The EPS-ECU 24 determines a target assist torque Fwt (target value of an assist torque Fw described later) based on, for example, the vehicle speed Vs, the steering angle, and the steering torque. The EPS-ECU 24 controls the steering motor 49 so that “assist torque Fw for rotating steering shaft” to be generated by the steering motor 49 is equal to the target assist torque Fwt.

Automatic Braking Control

Description is given of a process to be executed by the ECU 21 to detect a three-dimensional target in a forward-view image, and “automatic braking control” to be executed by the ECU 21 to avoid collision with the detected three-dimensional target.

In the following description, an X-Y coordinate system is used (see FIG. 1). The X-Y coordinate system has its origin at a front end of the driver's vehicle 10 at the center in a lateral direction. An X axis extends in a vehicle width direction of the driver's vehicle 10. AY axis extends in a fore-and-aft direction of the driver's vehicle 10. The X axis and the Y axis are orthogonal to each other. An X-coordinate value is a positive value in a rightward direction relative to a traveling direction of the driver's vehicle 10, and is a negative value in a leftward direction relative to the traveling direction of the driver's vehicle 10. A Y-coordinate value is a positive value in a forward direction of the driver's vehicle 10, and is a negative value in a rearward direction of the driver's vehicle 10.

The ECU 21 detects (extracts) a three-dimensional target such as another vehicle or a pedestrian based on a forward-view image (signal indicating a forward-view image) received from the front camera 31. More specifically, the ECU 21 detects the three-dimensional target from the forward-view image by using template matching. Therefore, the ECU 21 prestores various “templates” corresponding to other vehicles and pedestrians in the non-volatile memory.

When the forward-view image includes a region similar to one of the stored templates, the ECU 21 determines that the region includes a three-dimensional target corresponding to the template (corresponding template). That is, the ECU 21 detects (extracts) the three-dimensional target from the forward-view image in this case.

When the three-dimensional target is detected from the forward-view image, the ECU 21 acquires a type of the template corresponding to the three-dimensional target (that is, corresponding template) as a type of the three-dimensional target. In this embodiment, the types of three-dimensional targets (that is, types of the templates prestored in the ECU 21) include “other vehicles” and “pedestrian”.

The ECU 21 acquires a right end position and a left end position of the detected three-dimensional target relative to the driver's vehicle 10 by a related-art method. Each of the right end position and the left end position is represented by a combination of an X-coordinate value and a Y-coordinate value.

The ECU 21 acquires a distance in the Y-axis direction between the front end of the driver's vehicle 10 and the three-dimensional target as a longitudinal target distance Dty. Specifically, the ECU 21 acquires, as the longitudinal target distance Dty, a smaller one of a Y-coordinate value of the right end position and a Y-coordinate value of the left end position of the three-dimensional target.

The ECU 21 acquires a distance in the X-axis direction between the right end or the left end of the driver's vehicle 10 and the three-dimensional target as a transverse target distance Dtx. Specifically, the ECU 21 acquires, as a reference value Lq, a smaller one of the magnitude of an X-coordinate value of the right end position and the magnitude of an X-coordinate value of the left end position of the three-dimensional target. The ECU 21 acquires, as the transverse target distance Dtx, a difference between the reference value Lq and “half of vehicle width Wd of driver's vehicle 10 (see FIG. 1)” (that is, Dtx=Lq−(½)·Wd).

When a three-dimensional target detected from a forward-view image received last time from the front camera 31 by the ECU 21 (latest image) is also detected from an image received at a time before the last time (that is, an image acquired earlier by the time interval ΔTc than the time when the latest image is acquired), the ECU 21 acquires a moving speed of the three-dimensional target. The moving speed of the three-dimensional target is represented by a combination of a longitudinal target speed Vty and a transverse target speed Vtx.

The ECU 21 acquires the longitudinal target speed Vty by dividing “change amount ADty of longitudinal target distance Dty during elapse of time interval ΔTc” by the time interval ΔTc (that is, Vty=ΔDty/ΔTc). The ECU 21 acquires the transverse target speed Vtx by dividing “change amount ΔDtx of transverse target distance Dtx during elapse of time interval ΔTc” by the time interval ΔTc (that is, Vtx=ΔDtx/ΔTc).

Next, the automatic braking control to be executed by the ECU 21 is described. In the automatic braking control, a braking force Bf is generated in the brake mechanism 45 without a driver's operation for the brake pedal of the driver's vehicle 10 (that is, braking operation) when determination is made that the driver's vehicle 10 has a strong possibility of colliding with a three-dimensional target (specifically, a passing-region target or a crossing target described later). The automatic braking control to be executed by the ECU 21 includes “first braking control” and “second braking control”.

The first braking control is executed to avoid collision with a stopped target partially or entirely present in a region where the driver's vehicle 10 is expected to travel (that is, driver's vehicle passing region) (this target is hereinafter referred to also as “passing-region target”). The second braking control is executed to avoid collision with a target approaching to cross the driver's vehicle passing region of the driver's vehicle 10 (that is, candidate target) and determined to have a strong possibility of colliding with the driver's vehicle 10 as described later (this target is hereinafter referred to as “crossing target”). The candidate target includes another vehicle and a pedestrian.

Control for decelerating the driver's vehicle 10 at a maximum deceleration Amx by the ECU 21 during execution of the automatic braking control is hereinafter referred to also as “maximum braking control”. The maximum deceleration Amx is a positive value, and may be referred to as “second deceleration” for convenience. The maximum deceleration Amx is preset to a value equal to a highest deceleration As that can be achieved by the brake mechanism 45 in many cases. The maximum braking control is referred to also as “braking control for high-G braking” for convenience.

Control for decelerating the driver's vehicle 10 at “tentative deceleration Aw” by the ECU 21 during execution of the automatic braking control is hereinafter referred to also as “tentative braking control”. The tentative deceleration Aw is “positive value at magnitude smaller than magnitude of maximum deceleration Amx (0<Aw<Amx)”, and may be referred to as “first deceleration” for convenience. Thus, the magnitude (|Amx|) of the second deceleration (maximum deceleration Amx) is larger than the magnitude (|Aw51 ) of the first deceleration (tentative deceleration Aw). A method for acquiring (calculating) the tentative deceleration Aw is described later.

Automatic Braking Control—First Braking Control

The ECU 21 predicts the driver's vehicle passing region under the assumption that the driver's vehicle 10 is expected to travel while keeping current “vehicle speed, yaw rate, and steering angle”. The driver's vehicle passing region is a region between lines along which the right front end and the left front end of the driver's vehicle 10 pass (that is, a region where the front of the driver's vehicle 10 passes).

When the passing-region target is detected, the ECU 21 determines which of a maximum braking start necessary timing and a steering start necessary timing described later arrives first (earlier). When the ECU 21 determines that the maximum braking start necessary timing arrives before the steering start necessary timing, the ECU 21 starts the tentative braking control from “tentative braking start timing described later” instead of the maximum braking control, and then starts the maximum braking control at the steering start necessary timing as necessary. When the ECU 21 determines that the steering start necessary timing arrives before the maximum braking start necessary timing, the ECU 21 starts the maximum braking control at the maximum braking start necessary timing without executing the tentative braking control.

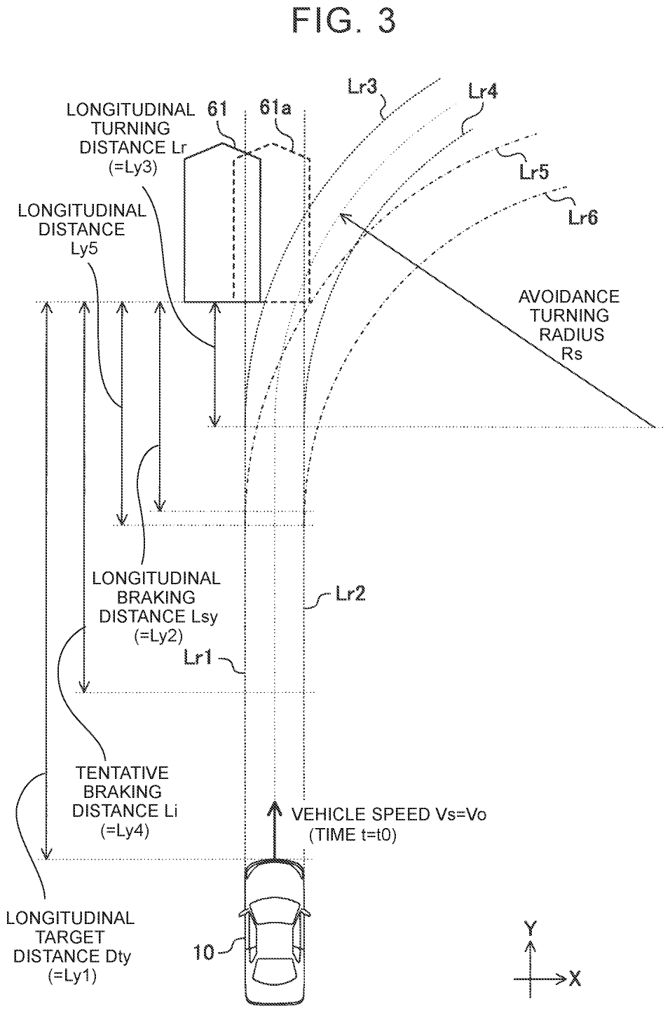

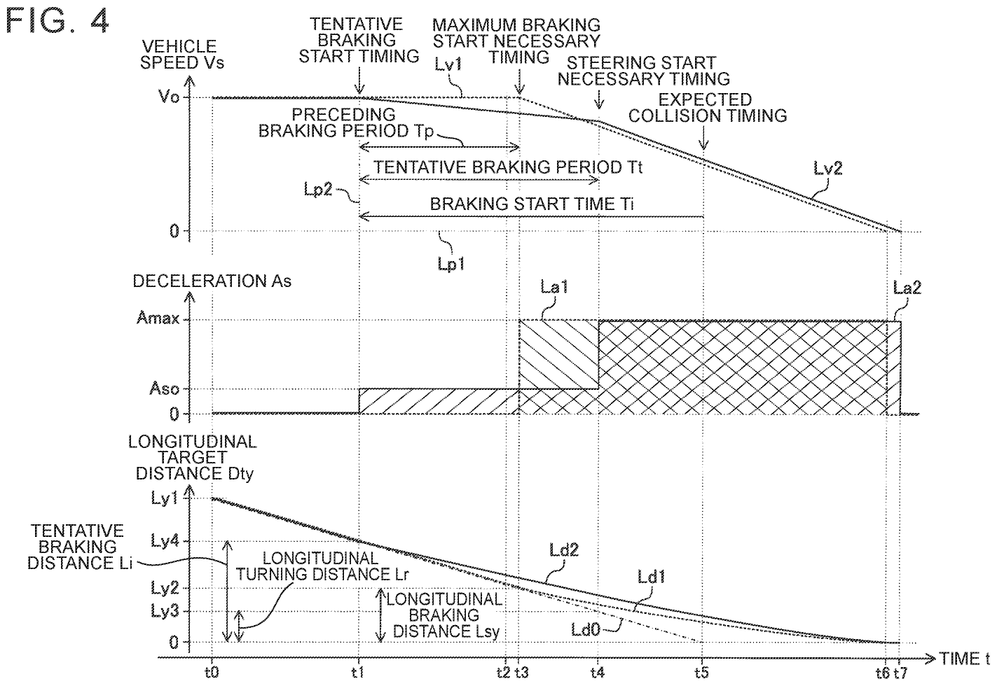

The first braking control is described below in detail with reference to an example illustrated in FIG. 3 (hereinafter referred to as “first example” for convenience). In the first example, the driver's vehicle 10 is traveling straightforward at a time t0. Thus, the driver's vehicle passing region is a region between a dashed line (straight line) Lr1 and a dashed line (straight line) Lr2. Another vehicle 61 is stopped in the driver's vehicle passing region. Thus, the other vehicle 61 is the passing-region target. As illustrated in FIG. 4, the vehicle speed Vs of the driver's vehicle 10 at the time t0 is a speed Vo, and the longitudinal target distance Dty is a longitudinal distance Ly1.

When the vehicle speed Vs is higher than “0” at a timing when the longitudinal target distance Dty is “0”, the driver's vehicle 10 collides with the other vehicle 61. In other words, when the longitudinal target distance Dty is “0” at a timing before a timing when the vehicle speed Vs decreases to “0”, the driver's vehicle 10 collides with the other vehicle 61.

When the driver's vehicle 10 does not decelerate after the time t0 (that is, when the vehicle speed Vs is kept at the speed Vo), the longitudinal target distance Dty reaches “0” at a time t5 as indicated by a long dashed short dashed line Ld0 in FIG. 4. The time t5 is a timing when a pre-collision allowance time TTC1 (=Ly1/Vo) has elapsed from the time t0. In this case, the driver's vehicle 10 collides with the other vehicle 61 at the time t5 because the vehicle speed Vs at the time t5 is the speed Vo. The “timing when the driver's vehicle 10 collides with passing-region target (time t5 in first example)” in a case where the vehicle speed Vs is kept without a change (decrease) is hereinafter referred to also as “expected collision timing”.

Next, description is given of the maximum braking control for avoiding collision between the driver's vehicle 10 and the other vehicle 61. To avoid collision between the driver's vehicle 10 and the other vehicle 61 through the maximum braking control, it is necessary that the longitudinal target distance Dty be equal to or larger than “0” (in actuality, distance margin Lm described later) when the vehicle speed Vs is “0” in a case where the driver's vehicle 10 is decelerated at the maximum deceleration Amx from a certain timing.

A distance traveled from a timing when the driver's vehicle 10 traveling at the speed Vo starts to decelerate at the maximum deceleration Amx to a timing when the driver's vehicle 10 is stopped is hereinafter referred to as “longitudinal braking distance Lsy”. A period from the timing when the driver's vehicle 10 starts to decelerate at the maximum deceleration Amx to the timing when the driver's vehicle 10 is stopped is “Vo/Amx”, and Expression (1) holds. In the first example, the longitudinal braking distance Lsy is a longitudinal distance Ly2 as illustrated in FIG. 3 and FIG. 4.

Lsy=(½)−(Vo)²/Amx (1)

When the maximum braking control is started (the driver's vehicle 10 starts to decelerate at the maximum deceleration Amx) at a timing when the longitudinal target distance Dty is equal to the longitudinal braking distance Lsy, the driver's vehicle 10 does not collide with the other vehicle 61. In this case, the vehicle speed Vs is indicated by a dashed line Lv1 in FIG. 4, the deceleration As is indicated by a dashed line La1 in FIG. 4, and the longitudinal target distance Dty is indicated by a dashed line Ld1 in FIG. 4. The timing when the longitudinal target distance Dty is equal to the longitudinal braking distance Lsy is hereinafter referred to also as “maximum braking start necessary timing” or “high-G braking start timing”. If the maximum braking control is started after the maximum braking start necessary timing has arrived (that is, at a timing after the maximum braking start necessary timing), there is a strong possibility that the vehicle speed Vs cannot reach “0” before the longitudinal target distance Dty reaches “0”.

The driver of the driver's vehicle 10 may be aware of the presence of the other vehicle 61, and intend to avoid collision with the other vehicle 61 through an operation for the steering wheel 51 (that is, turning operation). When a timing when the turning operation is necessary (hereinafter referred to also as “steering start necessary timing”) is later than the maximum braking start necessary timing, the maximum braking control is executed before the driver's turning operation. Thus, there is a strong possibility that the driver is bothered with the maximum braking control.

In view of the above, the ECU 21 determines which of the steering start necessary timing and the maximum braking start necessary timing arrives first (earlier, precedes the other) by calculating, in the following manner, a longitudinal target distance Dty when the steering start necessary timing has arrived (hereinafter referred to also as “longitudinal turning distance Lr”), and comparing the longitudinal turning distance Lr and the longitudinal braking distance Lsy. When the maximum braking start necessary timing arrives before the steering start necessary timing, the ECU 21 does not start the maximum braking control at the maximum braking start necessary timing.

If the driver's vehicle 10 starts to turn with a predetermined avoidance turning radius Rs at a timing after the steering start necessary timing, the collision with the passing-region target cannot be avoided. In other words, when the driver's vehicle 10 starts to turn with the avoidance turning radius Rs at a timing before the steering start necessary timing, the collision with the passing-region target can be avoided. The avoidance turning radius Rs is preset to a turning radius of a typical vehicle when a typical driver avoids collision with a passing-region target through a turning operation.

A driver's vehicle passing region in a case where the driver's vehicle 10 turns with the avoidance turning radius Rs from a timing when the steering start necessary timing has arrived (that is, a timing when the longitudinal target distance Dty is equal to the longitudinal turning distance Lr) is hereinafter referred to also as “turning passing region”. The turning passing region is defined as a region where the driver's vehicle 10 comes into contact with the end (right end or left end) of the other vehicle 61.

The ECU 21 determines, as “final turning passing region”, a tentative turning passing region in which the longitudinal turning distance Lr is smaller out of a tentative turning passing region in a case where the driver's vehicle 10 turns to the right and a tentative turning passing region in a case where the driver's vehicle 10 turns to the left. In the first example, the final turning passing region is the tentative turning passing region in the case where the driver's vehicle 10 turns to the right, and is a region between a dashed line Lr3 and a dashed line Lr4 in FIG. 3. In this case, the longitudinal turning distance Lr is a longitudinal distance Ly3.

It is assumed that the longitudinal turning distance Lr is smaller than the longitudinal braking distance Lsy when the longitudinal turning distance Lr is the longitudinal distance Ly3. In this case, the maximum braking start necessary timing arrives before the steering start necessary timing. Therefore, the ECU 21 does not start the maximum braking control at the maximum braking start necessary timing. Instead, the ECU 21 starts the tentative braking control at “tentative braking start timing (time t1)” earlier by a braking start time Ti than the expected collision timing (time t5) as illustrated in FIG. 4 to decelerate the driver's vehicle 10 at the tentative deceleration Aw. Methods for determining the braking start time Ti and the tentative deceleration Aw are described later. Since the magnitude of the tentative deceleration Aw is smaller than the magnitude of the maximum deceleration Amx, the possibility of driver's discomfort is small even though the tentative braking control is executed before the driver starts the turning operation. The tentative braking start timing is referred to also as “first timing” for convenience.

A longitudinal target distance Dty when the tentative braking start timing has arrived is referred to also as “tentative braking distance Li”. In the first example, the tentative braking distance Li is a longitudinal distance Ly4 (see FIG. 3). The ECU 21 calculates the tentative braking distance Li by multiplying the vehicle speed Vs (in this example, speed Vo) by the braking start time Ti (that is, Li=Vs·Ti). Upon arrival of a timing when the longitudinal target distance Dty is equal to the tentative braking distance Li, the ECU 21 determines that the tentative braking start timing has arrived.

When the driver does not perform the turning operation in a period before the steering start necessary timing (that is, the timing when the longitudinal target distance Dty is equal to the longitudinal turning distance Lr; time t4) arrives, the ECU 21 starts the maximum braking control at the steering start necessary timing (time t4). In this case, the vehicle speed Vs is indicated by a continuous line Lv2 in FIG. 4, the deceleration As is indicated by a continuous line La2 in FIG. 4, and the longitudinal target distance Dty is indicated by a continuous line Ld2 in FIG. 4. As understood from the continuous line Lv2 and the continuous line Ld2, both “vehicle speed Vs and longitudinal target distance Dty” are “0” at a time t7. In other words, the tentative deceleration Aw is determined so that the driver's vehicle 10 does not collide with the other vehicle 61 by starting the maximum braking control at the steering start necessary timing (time t4).

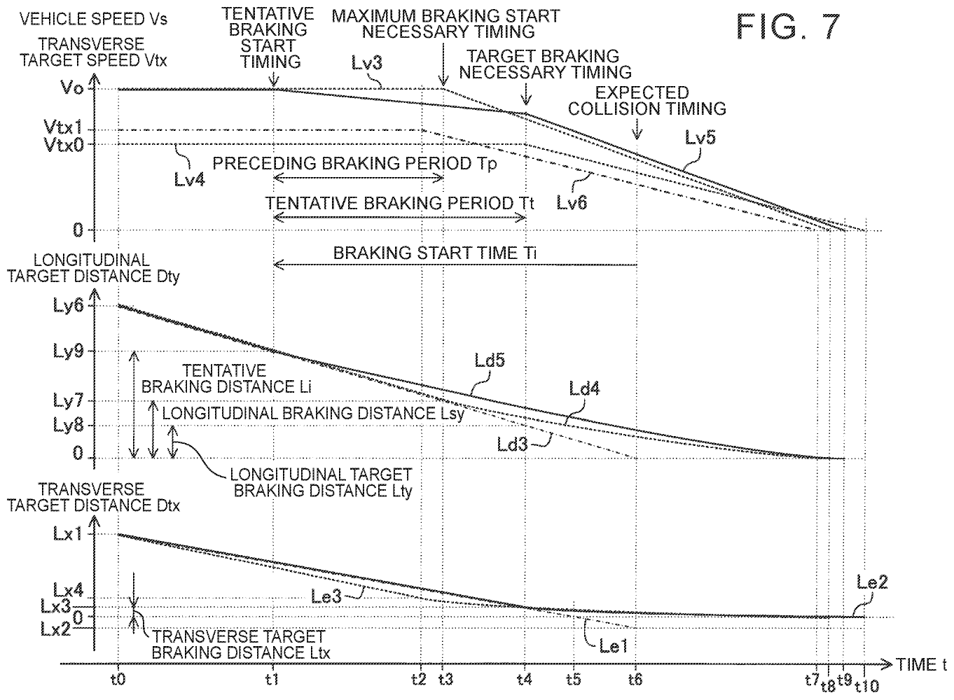

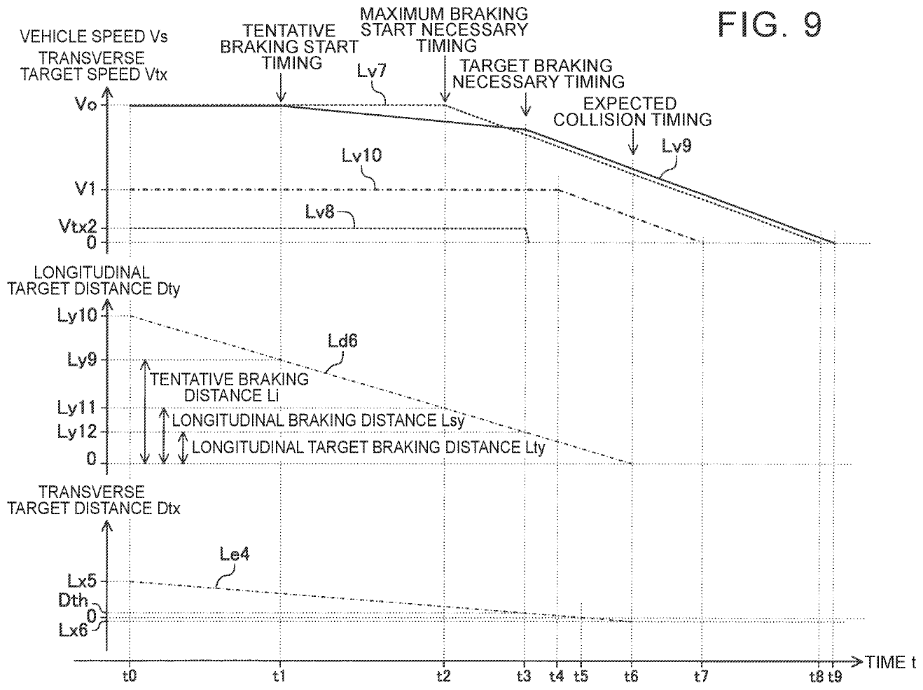

To determine the timings to start the tentative braking control and the maximum braking control, consideration is made on a time margin Tm obtained by dividing a predetermined distance margin Lm (see FIG. 1) by a vehicle speed Vs when the control timings are determined (that is, Tm=Lm/Vs). In the time chart of FIG. 4 (and time charts of FIG. 7 and FIG. 9 described later), the time margin Tm is regarded as “0”.

As described above, the tentative braking start timing is set as a timing earlier by the braking start time Ti than the expected collision timing. The braking start time Ti is acquired (calculated) based on Expression (2). In Expression (2), a coefficient k1 and a coefficient k2 are positive coefficients (fixed values) smaller than “1”, and the coefficient k2 is larger than the coefficient k1 (that is, 0<k1<k2<1).

Ti=1/(k2−k1·Vs) (2)

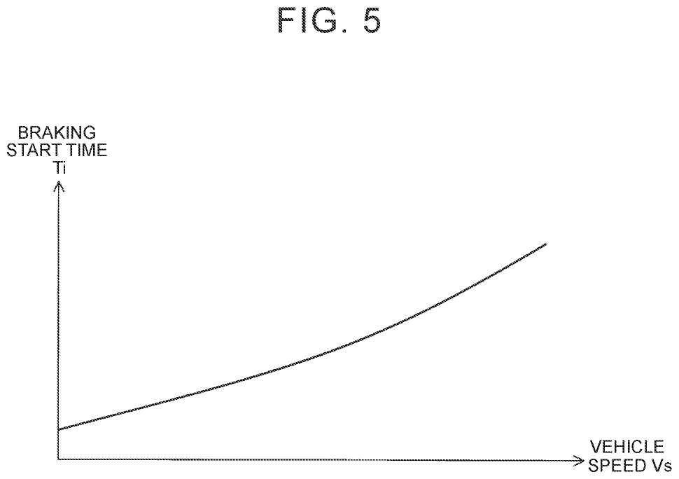

FIG. 5 illustrates “relationship between vehicle speed Vs and braking start time Ti” determined based on Expression (2). As understood from FIG. 5, the braking start time Ti increases as the vehicle speed Vs increases. The coefficient k1 and the coefficient k2 are preadapted so that, when a typical driver is aware of the presence of a passing-region target (or a crossing target), the tentative braking control is started after a timing when the driver starts a driving operation (braking operation and/or turning operation) to avoid collision with allowance.

The tentative deceleration Aw is calculated so that a traveling distance Ds1 and a traveling distance Ds2 described later are equal to each other.

The traveling distance Ds1 is a distance traveled by the driver's vehicle 10 during a period from the tentative braking start timing to the stop of the driver's vehicle 10 (from the time t1 to the time t7) when the tentative braking control is started at the tentative braking start timing and then the maximum braking control is started at the steering start necessary timing.

The traveling distance Ds2 is a distance traveled by the driver's vehicle 10 during a period from the tentative braking start timing to the stop of the driver's vehicle 10 (from the time t1 to the time t6) when the maximum braking control is started at the maximum braking start necessary timing without executing the tentative braking control.

The method for calculating the tentative deceleration Aw is described below in more detail. The traveling distance Ds1 is equal to the area of a region enclosed by the continuous line Lv2, an auxiliary line Lp1, and an auxiliary line Lp2 in FIG. 4.

Specifically, the area of this region is equal to the sum of the area of a trapezoid having one side as the continuous line Lv2 during a period from the time t1 to the time t4 (that is, a tentative braking period Tt in which the tentative braking control is being executed) and the area of a right triangle having a hypotenuse as the continuous line Lv2 during a period from the time t4 to the time t7. Thus, the traveling distance Ds1 is calculated based on Expression (3).

Ds1=(½)·{Vo+(Vo−Aw·Tt)}·Tt+(½)·(Vo−Aw·Tt)²/Amax (3)

The traveling distance Ds2 is equal to the area of a region enclosed by the dashed line Lv1, the auxiliary line Lp1, and the auxiliary line Lp2. Therefore, the traveling distance Ds2 is calculated based on Expression (4). In Expression (4), Tp represents the length of a period referred to as “preceding braking period”. The preceding braking period is a period from the tentative braking start timing (time t1) to the maximum braking start necessary timing (time t3).

Ds2=Vo·Tp+(½)·Vo²/Amax (4)

As described above, the tentative deceleration Aw is a deceleration when the traveling distance Ds1 and the traveling distance Ds2 are equal to each other. Thus, Expression (5) is obtained assuming that the right-hand side of Expression (3) and the right-hand side of Expression (4) are equal to each other. Expression (5a) is obtained by substituting the vehicle speed Vs for the speed Vo in Expression (5) (that is, the vehicle speed Vs at the time t0 in this example).

Tt²·Aw²−(Amax·Tt²+2·Vo·Tt)·Aw+2·Amax·Vo(Tt−Tp)=0 (5)

Tt²·Aw²−(Amax·Tt²+2·Vs·Tt)·Aw+2·Amax·Vs(Tt−Tp)=0 (5a)

Expression (5a) is a quadratic equation for the tentative deceleration Aw. The ECU 21 acquires, as the tentative deceleration Aw, a value that is a solution to Expression (5a) and falls within a range from “0” to the maximum deceleration Amx.

Next, description is given of the first braking control to be executed when the steering start necessary timing arrives before (earlier than) the maximum braking start necessary timing. For example, when another vehicle 61a is stopped at a position where the other vehicle 61a occupies a larger part of the driver's vehicle passing region than the other vehicle 61 as illustrated in FIG. 3, the turning passing region is a region between a long dashed short dashed line Lr5 and a long dashed short dashed line Lr6.

In this case, the longitudinal turning distance Lr is “longitudinal distance Ly5 larger than longitudinal distance Ly3” as illustrated in FIG. 3. As a result, it is assumed that the steering start necessary timing is “time t2 before time t4 (see FIG. 4)”. In this case, the steering start necessary timing (that is, time t2) arrives before the maximum braking start necessary timing (that is, time t3).

Thus, the situation in which the maximum braking control is started (that is, unnecessary strong braking) does not occur at a timing before the timing when the driver of the driver's vehicle 10 needs to start a turning operation to avoid collision with the other vehicle 61a. In this case, the tentative braking control is not executed. When the braking start necessary timing (time t3) has arrived without starting the driver's turning operation, the ECU 21 starts the maximum braking control at the maximum braking start necessary timing.

Automatic Braking Control—Second Braking Control—Other Vehicle

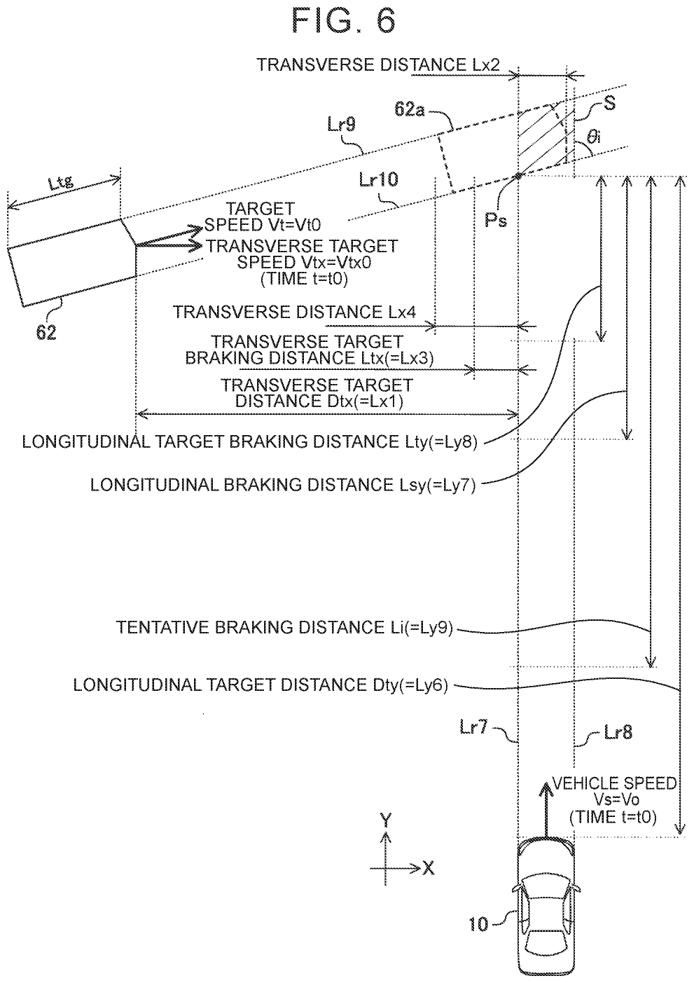

Next, the second braking control in a case where the type of the crossing target (candidate target) is a vehicle (other vehicle 62) is described in detail with reference to an example illustrated in FIG. 6 (hereinafter referred to as “second example” for convenience). The first braking control is performed in consideration of the case where the driver's vehicle 10 is turned to avoid collision. The second braking control is performed in consideration of a case where the crossing target (candidate target) decelerates.

In the second example, the driver's vehicle 10 is traveling straightforward at a time t0 similarly to the first example. Thus, the driver's vehicle passing region is a region between a dashed line (straight line) Lr7 and a dashed line (straight line) Lr8.

The other vehicle 62 that is the candidate target is traveling straightforward at the time t0 in a direction intersecting the driver's vehicle passing region. A traveling speed of the candidate target is referred to also as “target speed Vt”. Thus, an expected traveling region of the other vehicle 62 (hereinafter referred to also as “crossing target passing region”) is a region between a dashed line (straight line) Lr9 and a dashed line (straight line) Lr10. The crossing target passing region is referred to also as “target passing region” for convenience.

As illustrated in FIG. 6, the driver's vehicle passing region intersects the crossing target passing region at an intersecting angle θi. If the driver's vehicle passing region is parallel to the crossing target passing region, the intersecting angle θi is 0°.

Relationships of Expression (6a), Expression (6b), and Expression (6c) hold among the intersecting angle θi, the longitudinal target speed Vty (that is, a Y-axis component of the target speed Vt), and the transverse target speed Vtx (that is, an X-axis component of the target speed Vt). A relationship of Expression (7) holds among the target speed Vt, the longitudinal target speed Vty, and the transverse target speed Vtx.

Vtx=Vt·sin(θi) (6a)

Vty=Vt·cos(θi) (6b)

tan(θi)=Vtx/Vty (6c)

Vt²=Vty²+Vtx² (7)

A region where the driver's vehicle passing region overlaps the crossing target passing region is referred to also as “intersecting region S”. In FIG. 6, the intersecting region S is hatched.

When the driver's vehicle passing region intersects the crossing target passing region, the longitudinal target distance Dty is a distance in the Y-axis direction between the driver's vehicle 10 and “point Ps at smallest distance in Y-axis direction from driver's vehicle 10” being a point belonging to the intersecting region S, instead of the distance in the Y-axis direction between the driver's vehicle 10 and the crossing target. Thus, the longitudinal target distance Dty in the second example is a distance in the Y-axis direction between the driver's vehicle 10 and the point Ps that is an intersection of the dashed line Lr7 and the dashed line Lr10.

In the second example, the other vehicle 62 is located on the left of the driver's vehicle 10. Thus, the transverse target distance Dtx is a distance in the X-axis direction between the left end of the driver's vehicle 10 and the front end of the other vehicle 62 (to be exact, right front end or left front end). When the other vehicle that is the crossing target is located on the right of the driver's vehicle 10, the transverse target distance Dtx is a distance in the X-axis direction between the right end of the driver's vehicle 10 and the front end of the other vehicle.

At the time t0 in FIG. 6, the vehicle speed Vs is the speed Vo, the longitudinal target distance Dty is a longitudinal distance Ly6, and the transverse target distance Dtx is a transverse distance Lx1. At the time t0, the target speed Vt is a speed Vt0, and the transverse target speed Vtx is a speed Vtx0.

When the other vehicle 62 is located in the intersecting region S at a timing when the driver's vehicle 10 reaches (enters) the intersecting region S (that is, a timing when the longitudinal target distance Dty reaches “0”) in a case where both the driver's vehicle 10 and the other vehicle 62 keep their speeds at the time t0 without deceleration, both the vehicles collide with each other. Similarly, when the driver's vehicle 10 is located in the intersecting region S at a timing when the other vehicle 62 reaches (enters) the intersecting region S (that is, a timing when the transverse target distance Dtx reaches “0”) in the case where both the driver's vehicle 10 and the other vehicle 62 keep their speeds at the time t0 without deceleration, both the vehicles collide with each other.

In the second example, when the driver's vehicle 10 starts to enter the intersecting region S in the case where both the driver's vehicle 10 and the other vehicle 62 keep their speeds at the time t0 without deceleration, the other vehicle 62 has already entered the intersecting region S and has already been located in the intersecting region S.

When the driver's vehicle 10 does not decelerate after the time t0 (that is, when the vehicle speed Vs is kept at the speed Vo), the longitudinal target distance Dty reaches “0” at a time t6 as indicated by a long dashed short dashed line Ld3 in FIG. 7. That is, the driver's vehicle 10 enters the intersecting region S at the time t6. The time t6 is a timing when a pre-collision allowance time TTC2 (=Ly6/Vo) has elapsed from the time t0.

When the other vehicle 62 does not decelerate after the time t0, the transverse target speed Vtx is kept at the speed Vtx0. In this case, the transverse target distance Dtx reaches “0” at a time t5 as indicated by a long dashed short dashed line Le1 in FIG. 7. That is, the other vehicle 62 enters the intersecting region S at the time t5. The time t5 is a timing when an other-vehicle allowance time TTCT (=Lx1/Vtx0) has elapsed from the time t0, and is a timing before the time t6 in the second example.

At the time t6 when the driver's vehicle 10 enters the intersecting region S, the transverse target distance Dtx is a transverse distance Lx2. At this timing, the position of the other vehicle 62 is a vehicle position 62a in FIG. 6. In the second example, the transverse distance Lx2 is larger than “0” and equal to or smaller than “sum of vehicle width Wd, product of longitudinal length Ltg of other vehicle 62 and sin(θi), and predetermined value α” (that is, 0<Lx2≤Wd+Ltg·sin(θi)+α). That is, in the second example, the other vehicle 62 is located substantially in the intersecting region S at the timing when the driver's vehicle 10 enters the intersecting region S. Thus, the driver's vehicle 10 collides with the other vehicle 62 at the time t6. That is, the time t6 is the expected collision timing in the second example. The predetermined value a is preset based on deviations of the position and the moving speed of the three-dimensional target acquired based on the forward-view image (acquisition deviations).

In the second example, the longitudinal braking distance Lsy is determined based on Expression (1), and is a longitudinal distance Ly7 (see FIG. 6). Thus, a timing when the longitudinal target distance Dty is equal to the longitudinal distance Ly7 is the maximum braking start necessary timing. A vehicle speed Vs when the maximum braking control is started at the maximum braking start necessary timing is indicated by a dashed line Lv3 in FIG. 7. In this case, the longitudinal target distance Dty is indicated by a dashed line Ld4 in FIG. 7. As indicated by the dashed line Lv3, the vehicle speed Vs reaches “0” at the time t8. Therefore, the driver's vehicle 10 is stopped, and the longitudinal target distance Dty reaches “0”. Thus, the driver's vehicle 10 is stopped at a position immediately before the driver's vehicle 10 enters the intersecting region S, and does not collide with the other vehicle 62.

For example, a driver of the other vehicle 62 or an automatic braking device mounted on the other vehicle 62 may decelerate the other vehicle 62 by applying a brake to the other vehicle 62 to avoid collision with the driver's vehicle 10. When the brake is applied to the other vehicle 62 before an appropriate timing (hereinafter referred to also as “target braking necessary timing”), the other vehicle 62 does not enter the intersecting region S. In this case, it is not preferable to decelerate the driver's vehicle 10 through the maximum braking control. That is, when the target braking necessary timing is later than the maximum braking start necessary timing, unnecessary maximum braking control (unnecessary strong braking) is performed, and the driver of the driver's vehicle 10 may feel extreme discomfort.

In view of the above, the ECU 21 determines which of the target braking necessary timing and the maximum braking start necessary timing arrives first by calculating, as a transverse target braking distance Ltx in the following manner, a transverse target distance Dtx when the target braking necessary timing arrives, and comparing a timing when the transverse target distance Dtx is equal to the transverse target braking distance Ltx (that is, target braking necessary timing) and a timing when the longitudinal target distance Dty is equal to the longitudinal braking distance Lsy (in the second example, longitudinal distance Ly7) (that is, maximum braking start necessary timing). When the maximum braking start necessary timing arrives before the target braking necessary timing, the ECU 21 does not start the maximum braking control at the maximum braking start necessary timing. The target braking necessary timing is referred to also as “second timing” for convenience.

In actuality, the ECU 21 determines which of the target braking necessary timing and the maximum braking start necessary timing arrives first by determining, as a longitudinal target braking distance Lty, a longitudinal target distance Dty at the timing when the transverse target distance Dtx is equal to the transverse target braking distance Ltx, and comparing a timing when the longitudinal target distance Dty is equal to the longitudinal target braking distance Lty (that is, target braking necessary timing) and the timing when the longitudinal target distance Dty is equal to the longitudinal braking distance Lsy (that is, maximum braking start necessary timing).

Specifically, the transverse target braking distance Ltx is a transverse distance Lx3, and the longitudinal target braking distance Lty is a longitudinal distance Ly8 in the second example (see FIG. 6). A period obtained by dividing the transverse distance Lx3 by the speed Vtx0 and a period obtained by dividing the longitudinal distance Ly8 by the speed Vo are equal to the length of a period from a time t4 to the time t6 (that is, Lx3/ Vtx0=Ly8/Vo=t6−t4).

The target braking necessary timing is a timing immediately before a timing when the other vehicle 62 cannot be stopped at a position immediately behind the intersecting region S even though the other vehicle 62 starts to decelerate at a predetermined target deceleration (expected target deceleration) At. In other words, when the other vehicle 62 starts to decelerate at the target deceleration At at a timing before the target braking necessary timing, the other vehicle 62 does not enter the intersecting region S, and can avoid collision with the driver's vehicle 10. The target deceleration At is preset to a typical deceleration to be achieved by a typical driver in a vehicle to avoid collision.

The transverse target braking distance Ltx when the crossing target is the other vehicle is equal to a decrease amount (magnitude of decrease amount) of the transverse target distance Dtx during a period from a timing when the crossing target (in the second example, other vehicle 62) starts to decelerate at the target deceleration At to a timing when the crossing target is stopped.

A braking distance Lo traveled by the crossing target traveling at the target speed Vt (in the second example, speed Vt0) during “period before timing when target speed Vt reaches “0” by decelerating crossing target at target deceleration At” is calculated based on Expression (8) that is an analogy to Expression (1). Therefore, the transverse target braking distance Ltx is calculated based on Expression (9).

Lo=(½)·(Vt)²/At (8)

Ltx=Lo·sin(θi)={(½)·(Vt)²/At}·sin(θi) (9)

It is assumed that the timing when the transverse target distance Dtx is equal to the transverse target braking distance Ltx (that is, target braking necessary timing) is the time t4 in FIG. 7 and the transverse target braking distance Ltx is the transverse distance Lx3. A transverse target speed Vtx when the other vehicle 62 starts to decelerate at the target deceleration At at the time t4 is indicated by a dashed line Lv4 in FIG. 7. In this case, the transverse target distance Dtx is indicated by a continuous line Le2 in FIG. 7. As indicated by the dashed line Lv4, the transverse target speed Vtx reaches “0” at a time t10. Therefore, the other vehicle 62 is stopped, and the transverse target distance Dtx reaches “0”. Thus, the other vehicle 62 is stopped before entering the intersecting region S, and does not collide with the driver's vehicle 10.

When the maximum braking start necessary timing (time t3) arrives before (earlier than) the target braking necessary timing (time t4), the ECU 21 does not start the maximum braking control at the maximum braking start necessary timing. Instead, the ECU 21 starts the tentative braking control at “tentative braking start timing (time t1)” earlier by the braking start time Ti than the expected collision timing (time t6) as illustrated in FIG. 7 to decelerate the driver's vehicle 10 at the tentative deceleration Aw. The braking start time Ti and the tentative deceleration Aw are calculated similarly to those in the first braking control. The ECU 21 calculates a tentative braking distance Li by multiplying the vehicle speed Vs (in this example, speed Vo) by the braking start time Ti (that is, Li=Vs·Ti). Upon arrival of a timing when the longitudinal target distance Dty is equal to the tentative braking distance Li, the ECU 21 determines that the tentative braking start timing has arrived. In the second example, the tentative braking distance Li is a longitudinal distance Ly9.

A tentative braking period (period in which the tentative braking control is being executed) Tt in the second braking control is a period from the tentative braking start timing (time t1) to the target braking necessary timing (time t4).

When the other vehicle 62 does not start to decelerate in a period before the target braking necessary timing (time t4) arrives, the ECU 21 starts the maximum braking control at the target braking necessary timing. In this case, the vehicle speed Vs is indicated by a continuous line Lv5 in FIG. 7, and the longitudinal target distance Dty is indicated by a continuous line Ld5 in FIG. 7. As understood from the continuous line Lv5 and the continuous line Ld5, both “vehicle speed Vs and longitudinal target distance Dty” are “0” at a time t9. Thus, the driver's vehicle 10 is stopped before entering the intersecting region S, and does not collide with the other vehicle 62.

Next, description is given of the second braking control to be executed when the target braking necessary timing arrives before the maximum braking start necessary timing. For example, it is assumed that the transverse target speed Vtx of the other vehicle 62 at the time t0 is “speed Vtx1 higher than speed Vtx0” as illustrated in FIG. 7 and therefore the target braking necessary timing is “time t2 before time t4”. In this case, the transverse target braking distance Ltx is a transverse distance Lx4.

When the other vehicle 62 starts to decelerate at the target deceleration At at the target braking necessary timing (time t2), the transverse target speed Vtx changes as indicated by a long dashed short dashed line Lv6 in FIG. 7, and the transverse target distance Dtx changes as indicated by a long dashed short dashed line Le3 in FIG. 7. In this case, the transverse target speed Vtx reaches “0” at a time t7. Therefore, the other vehicle 62 is stopped, and the transverse target distance Dtx reaches “0”. Thus, the other vehicle 62 is stopped before entering the intersecting region S, and does not collide with the driver's vehicle 10.

In other words, when the other vehicle 62 traveling at the speed Vtx1 does not start to decelerate before the time t2 (that is, target braking necessary timing), the other vehicle 62 has a strong possibility of entering the intersecting region S. In this case (that is, in the case where the target braking necessary timing arrives before the maximum braking start necessary timing), the ECU 21 does not execute the tentative braking control. The ECU 21 starts the maximum braking control at the maximum braking start necessary timing (that is, time t3).

Automatic Braking Control—Second Braking Control—Pedestrian

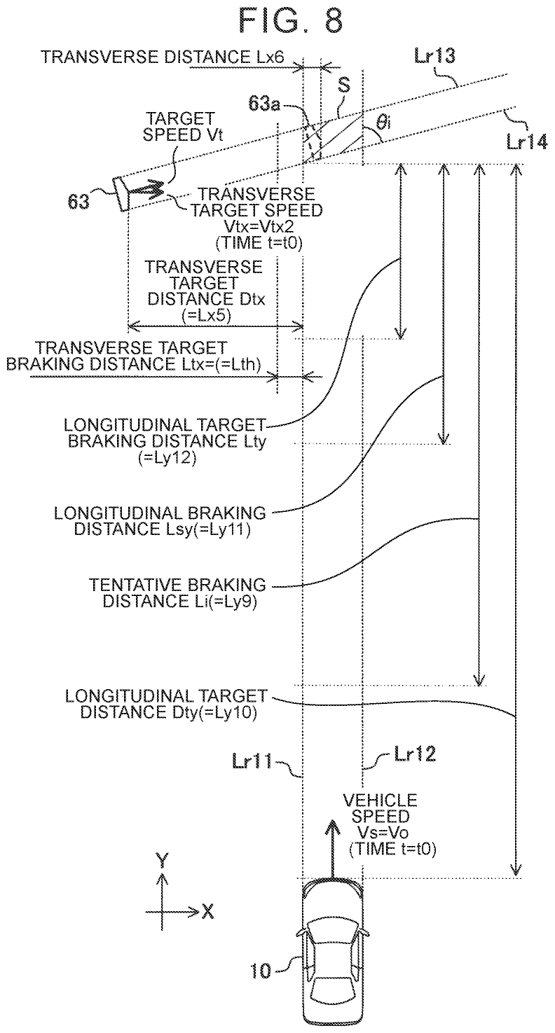

Next, the second braking control in a case where the type of the crossing target is a pedestrian 63 is described in detail with reference to an example illustrated in FIG. 8 (hereinafter referred to as “third example” for convenience).

In the third example, the driver's vehicle 10 is traveling straightforward at a time t0 similarly to the first example and the second example. Thus, the driver's vehicle passing region is a region between a dashed line (straight line) Lr11 and a dashed line (straight line) Lr12.

The pedestrian 63 is walking straightforward at the target speed Vt at the time t0 in a direction intersecting the driver's vehicle passing region at the intersecting angle θi. Thus, an expected traveling region of the pedestrian 63 (crossing target passing region) is a region between a dashed line (straight line) Lr13 and a dashed line (straight line) Lr14.

At the time t0 in FIG. 8, the vehicle speed Vs is the speed Vo, the longitudinal target distance Dty is a longitudinal distance Ly10, and the transverse target distance Dtx is a transverse distance Lx5. At the time t0, the transverse target speed Vtx is a speed Vtx2.

When the driver's vehicle 10 keeps the speed Vo at the time t0 without deceleration in the third example as illustrated in FIG. 9, the longitudinal target distance Dty reaches “0” at a time t6 as indicated by a long dashed short dashed line Ld6 in FIG. 9. That is, the driver's vehicle 10 enters the intersecting region S at the time t6. The time t6 is a timing when a pre-collision allowance time TTC3 (=Ly10/Vo) has elapsed from the time t0.

When the pedestrian 63 does not decelerate after the time t0, the transverse target speed Vtx is kept at the speed Vtx2. In this case, the transverse target distance Dtx reaches “0” at a time t5 as indicated by a long dashed short dashed line Le4 in FIG. 9. That is, the pedestrian 63 enters the intersecting region S at the time t5. The time t5 is a timing when a pedestrian allowance time TTCP (=Lx5/Vtx2) has elapsed from the time t0, and is a timing before the time t6 in the third example.

At the time t6 when the driver's vehicle 10 enters the intersecting region S, the transverse target distance Dtx is a transverse distance Lx6. At this timing, the position of the pedestrian 63 is a pedestrian position 63a in FIG. 8. In the third example, the transverse distance Lx6 is equal to or smaller than “sum of vehicle width Wd of driver's vehicle 10 and predetermined value α (=Wd+α)”. That is, in the third example, the pedestrian 63 is located substantially in the intersecting region S at the timing when the driver's vehicle 10 enters the intersecting region S. Thus, the driver's vehicle 10 collides with the pedestrian 63 at the time t6. That is, the time t6 is the expected collision timing in the third example.

In the third example, the longitudinal braking distance Lsy is determined based on Expression (1), and is a longitudinal distance Ly11 (see FIG. 8). Thus, a timing when the longitudinal target distance Dty is equal to the longitudinal distance Ly11 is the maximum braking start necessary timing. A vehicle speed Vs when the maximum braking control is started at the maximum braking start necessary timing is indicated by a dashed line Lv7 in FIG. 9. As indicated by the dashed line Lv7, the vehicle speed Vs reaches “0”, and the driver's vehicle 10 is stopped at a time t8. At this time, the longitudinal target distance Dty is “0”. Thus, the driver's vehicle 10 is stopped before entering the intersecting region S, and does not collide with the pedestrian 63.

The pedestrian 63 may stop to avoid collision with the driver's vehicle 10. When the type of the crossing target is “pedestrian”, the ECU 21 sets the transverse target braking distance Ltx to a predetermined distance threshold Lth (see FIG. 8). The distance threshold Lth is preset based on a position where a typical pedestrian stops to avoid collision with a vehicle approaching to cross the pedestrian. The distance threshold Lth is set to a distance substantially equal to a distance between a typical pedestrian and the driver's vehicle passing region when the pedestrian stops to avoid collision with the vehicle (predetermined allowance distance), or to a distance obtained by adding a predetermined margin to the predetermined allowance distance.

When the type of the crossing target is “pedestrian”, the driver's vehicle 10 and the pedestrian 63 do not collide with each other without executing the maximum braking control if the crossing target starts to decelerate before a timing when the transverse target distance Dtx reaches “distance threshold Lth that is transverse target braking distance Ltx” (that is, target braking necessary timing). A transverse target speed Vtx when the pedestrian 63 starts to decelerate at the target braking necessary timing (in the third example, time t3) is indicated by a dashed line Lv8 in FIG. 9. As indicated by the dashed line Lv8, a period from the start of deceleration of the pedestrian 63 to the stop of the pedestrian 63 is extremely short.

In view of the above, the ECU 21 determines which of the target braking necessary timing and the maximum braking start necessary timing arrives first by comparing “timing when transverse target distance Dtx is equal to distance threshold Lth that is transverse target braking distance Ltx (that is, target braking necessary timing)” and “timing when longitudinal target distance Dty is equal to longitudinal braking distance Lsy (in third example, longitudinal distance Ly11) (that is, maximum braking start necessary timing)”.

When the transverse target distance Dtx of the pedestrian approaching the driver's vehicle passing region is larger than the distance threshold Lth upon arrival of the maximum braking start necessary timing, the pedestrian may stop before entering the intersecting region S.

Thus, when the maximum braking start necessary timing (time t2) arrives before “target braking necessary timing (time t3) when transverse target distance Dtx of pedestrian approaching driver's vehicle passing region is equal to distance threshold Lth”, the ECU 21 does not start the maximum braking control at the maximum braking start necessary timing. Instead, the ECU 21 starts the tentative braking control at “tentative braking start timing (time t1)” earlier by the braking start time Ti than the expected collision timing (time t6) as illustrated in FIG. 9 to decelerate the driver's vehicle 10 at the tentative deceleration Aw. The braking start time Ti and the tentative deceleration Aw are calculated similarly to those in the first braking control.

When the pedestrian 63 does not stop in a period before the target braking necessary timing (time t3) arrives, the ECU 21 starts the maximum braking control at the target braking necessary timing. In this case, the vehicle speed Vs is indicated by a continuous line Lv9 in FIG. 9. As described above, both “vehicle speed Vs and longitudinal target distance Dty” reach “0” at a time t9 as a result of the braking control. Thus, the driver's vehicle 10 is stopped before entering the intersecting region S, and does not collide with the pedestrian 63.

When the target braking necessary timing (timing when the transverse target distance Dtx of the moving pedestrian approaching the driver's vehicle passing region is equal to the distance threshold Lth) arrives before the maximum braking start necessary timing, there is a strong possibility that the pedestrian is not aware of the presence of the driver's vehicle 10 and therefore enters the intersecting region S.

An example of the vehicle speed Vs in this case is indicated by a long dashed short dashed line Lv10 in FIG. 9. In this case, the vehicle speed Vs at the time t0 is a speed V1 lower than the speed Vo. In this case, the ECU 21 does not execute the tentative braking control. The ECU 21 starts the maximum braking control when the transverse target distance Dtx from the pedestrian 63 is equal to the distance threshold Lth (that is, at a time t4 that is the maximum braking start necessary timing).

Specific Operations

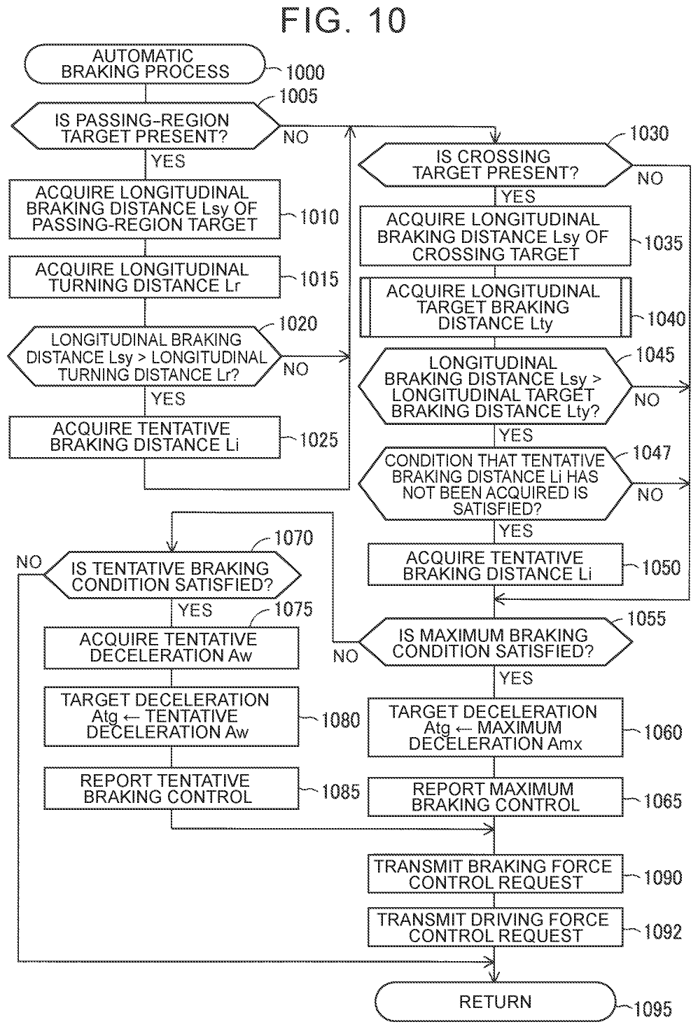

Next, specific operations of the ECU 21 are described. The CPU of the ECU 21 (hereinafter simply referred to also as “CPU”) executes “automatic braking process routine” in a flowchart of FIG. 10 every time a predetermined period has elapsed. The CPU executes a routine (not illustrated) every time a predetermined period has elapsed to acquire, based on a forward-view image, “right end position, left end position, and moving speed” of a three-dimensional target in the forward-view image.

At a predetermined timing, the CPU starts the process from Step 1000 of FIG. 10, and proceeds to Step 1005. The CPU determines whether a passing-region target is present.

When the passing-region target is present, the CPU determines “Yes” in Step 1005, and proceeds to Step 1010. The CPU acquires a longitudinal braking distance Lsy of the passing-region target based on Expression (1).

Subsequently, the CPU proceeds to Step 1015, and acquires a longitudinal turning distance Lr as described above. That is, the CPU acquires “turning passing region with avoidance turning radius Rs” that can avoid collision with the passing-region target and “turning passing region with smallest longitudinal turning distance Lr”, and acquires the longitudinal turning distance Lr corresponding to that turning passing region.

The CPU proceeds to Step 1020, and determines whether the longitudinal braking distance Lsy is larger than the longitudinal turning distance Lr (that is, whether the maximum braking start necessary timing arrives before the steering start necessary timing). When the longitudinal braking distance Lsy is larger than the longitudinal turning distance Lr, the CPU determines “Yes” in Step 1020, and proceeds to Step 1025. As described above, the CPU acquires a tentative braking distance Li to the passing-region target.

More specifically, the CPU acquires a braking start time Ti by applying a vehicle speed Vs to Expression (2). The CPU acquires the tentative braking distance Li by multiplying the vehicle speed Vs by the braking start time Ti (that is, Li=Vs·Ti). The CPU proceeds to Step 1030. After the process of Step 1025 is completed, the CPU may directly proceed to Step 1055 described later. In this case, a process of Step 1047 described later is omitted.

When the longitudinal braking distance Lsy is equal to or smaller than the longitudinal turning distance Lr, the CPU determines “No” in Step 1020, and directly proceeds to Step 1030. When the determination condition in Step 1005 is not satisfied (that is, when the passing-region target is not present), the CPU determines “No” in Step 1005, and directly proceeds to Step 1030.

In Step 1030, the CPU determines whether a crossing target is present. More specifically, the CPU determines whether a target approaching a driver's vehicle passing region (that is, candidate target) is present. When the candidate target is present, the CPU determines whether the type of the candidate target is “other vehicle” or “pedestrian”. In this embodiment, the other vehicle includes a motorcycle. The CPU determines whether a period in which the driver's vehicle 10 is present in an intersecting region when the driver's vehicle 10 keeps a current vehicle speed Vs and a period in which the candidate target is present in the intersecting region when the candidate target keeps a current target speed Vt (candidate target speed) have an overlapping part (hereinafter referred to as “overlapping period”).

When the overlapping period is present, the candidate target having the overlapping period is determined as the crossing target. In this case, the CPU determines “Yes” in Step 1030, and proceeds to Step 1035. In Step 1035, the CPU acquires a longitudinal braking distance Lsy of the crossing target based on Expression (1).

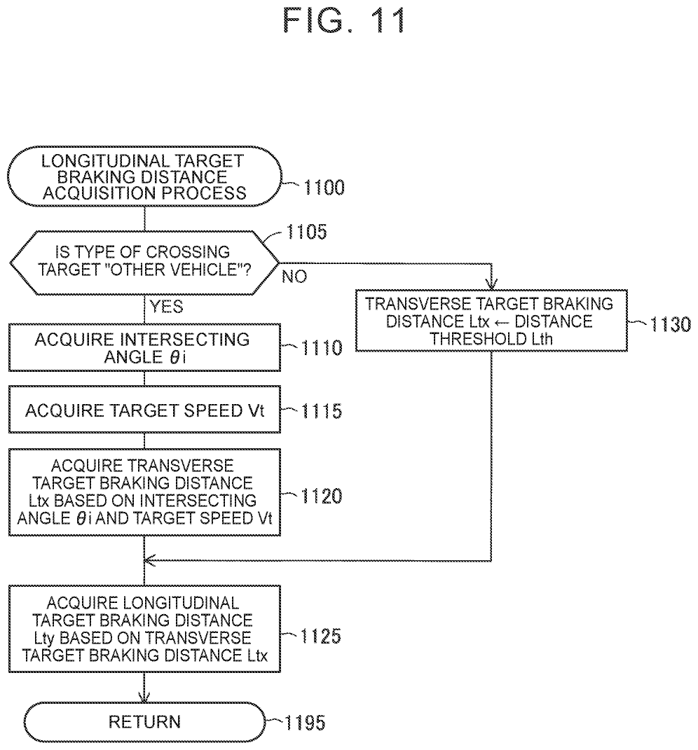

Subsequently, the CPU proceeds to Step 1040, and acquires a longitudinal target braking distance Lty of the crossing target. More specifically, the CPU executes “longitudinal target braking distance acquisition process routine” in a flowchart of FIG. 11. The CPU starts the process from Step 1100 of FIG. 11, and proceeds to Step 1105. The CPU determines whether the type of the crossing target is “other vehicle”.

When the type of the crossing target is “other vehicle”, the CPU determines “Yes” in Step 1105, and sequentially executes the following processes of Step 1110 to Step 1125. Subsequently, the CPU proceeds to Step 1195 to terminate the processes of the routine of FIG. 11, and proceeds to Step 1045 of FIG. 10.

Step 1110: The CPU acquires an intersecting angle θi based on Expression (6c).

Step 1115: The CPU acquires a target speed Vt based on Expression (7).

Step 1120: The CPU acquires a transverse target braking distance Ltx by substituting the intersecting angle θi and the target speed Vt into Expression (9).

Step 1125: The CPU acquires the longitudinal target braking distance Lty based on the transverse target braking distance Ltx. That is, the CPU acquires, as the longitudinal target braking distance Lty, a longitudinal target distance Dty at a timing when a transverse target distance Dtx is equal to the transverse target braking distance Ltx. In this embodiment, the CPU acquires (calculates) the longitudinal target braking distance Lty as a product of the transverse target braking distance Ltx and “value obtained by dividing vehicle speed Vs by transverse target speed Vtx” (that is, Lty=Ltx·Vs/Vtx).

When the type of the crossing target is not “other vehicle” (that is, the type of the crossing target is “pedestrian”), the CPU determines “No” in Step 1105, and proceeds to Step 1130. The CPU sets the transverse target braking distance Ltx to a value equal to the distance threshold Lth. Subsequently, the CPU proceeds to Step 1125.

In Step 1045 of FIG. 10, the CPU determines whether the longitudinal braking distance Lsy is larger than the longitudinal target braking distance Lty (that is, whether the maximum braking start necessary timing arrives before the target braking necessary timing). When the longitudinal braking distance Lsy is larger than the longitudinal target braking distance Lty, the CPU determines “Yes” in Step 1045, and proceeds to Step 1047. The CPU determines whether the condition that the tentative braking distance Li has not been acquired is satisfied.

That is, the CPU determines whether the process of Step 1025 is not executed during the current execution of the processes of this routine and therefore the condition that the tentative braking distance Li has not been acquired is satisfied. When the condition that the tentative braking distance Li has not been acquired is satisfied, the CPU determines “Yes” in Step 1047, and proceeds to Step 1050. The CPU acquires the tentative braking distance Li through a process similar to that of Step 1025. Subsequently, the CPU proceeds to Step 1055.

When the condition that the tentative braking distance Li has not been acquired is not satisfied, the CPU determines “No” in Step 1047, and directly proceeds to Step 1055. When the determination condition in Step 1030 is not satisfied (that is, when the crossing target is not present), the CPU determines “No” in Step 1030, and directly proceeds to Step 1055. When the determination condition in Step 1045 is not satisfied (that is, when the longitudinal braking distance Lsy is equal to or smaller than the longitudinal target braking distance Lty), the CPU determines “No” in Step 1045, and directly proceeds to Step 1055.

In Step 1055, the CPU determines whether “maximum braking condition” is satisfied. The maximum braking condition is satisfied when the maximum braking control needs to be executed (that is, the driver's vehicle 10 needs to decelerate at the maximum deceleration Amx). Specifically, the maximum braking condition is satisfied when at least one of (Condition a) to (Condition c) is satisfied.

(Condition a): After the tentative braking control is started for the passing-region target, the longitudinal target distance Dty of the passing-region target is equal to or smaller than “distance obtained by adding distance margin Lm to longitudinal turning distance Lr” (that is, Dty≤Lr+Lm).

(Condition b): After the tentative braking control is started for the crossing target, the longitudinal target distance Dty of the crossing target is equal to or smaller than “distance obtained by adding distance margin Lm to longitudinal target braking distance Lty” (that is, Dty≤Lty+Lm).

(Condition c): The tentative braking control is not started, and the longitudinal target distance Dty is equal to or smaller than “distance obtained by adding distance margin Lm to longitudinal braking distance Lsy” (that is, Dty≤Lsy+Lm).

For example, when a crossing target that triggers the second braking control is present and the longitudinal braking distance Lsy is smaller than the longitudinal target braking distance Lty, the tentative braking control is not executed for the crossing target. In this case, (Condition c) is satisfied when the longitudinal target distance Dty to the crossing target is equal to “distance obtained by adding distance margin Lm to longitudinal braking distance Lsy”. In other words, (Condition c) is satisfied at a timing earlier by the time margin Tm than the maximum braking start necessary timing.

The determination of whether “(Condition a), (Condition b), and (Condition c)” and “(Condition d) and (Condition e)” described later are satisfied is made by using various parameters acquired during the current execution of this routine (such as the longitudinal turning distance Lr and the longitudinal target braking distance Lty). In other words, parameters acquired during previous execution (or further previous execution) of this routine are not referred to in the determination of whether the conditions are satisfied.

When none of (Condition a), (Condition b), and (Condition c) is satisfied, the CPU determines “No” in Step 1055, and proceeds to Step 1070. The CPU determines whether “tentative braking condition” is satisfied.

The tentative braking condition is satisfied when the tentative braking control needs to be executed (that is, the driver's vehicle 10 needs to decelerate at the tentative deceleration Aw). More specifically, the tentative braking condition is satisfied when at least one of (Condition d) and (Condition e) is satisfied.

(Condition d): The longitudinal target distance Dty of the passing-region target is equal to or smaller than “distance obtained by adding distance margin Lm to tentative braking distance Li for passing-region target” (that is, Dty≤Li+Lm).

(Condition e): The longitudinal target distance Dty of the crossing target (that is, the distance in the Y-axis direction between the intersecting region S and the driver's vehicle 10) is equal to or smaller than “distance obtained by adding distance margin Lm to tentative braking distance Li for crossing target” (that is, Dty≤Li+Lm).

When neither (Condition d) nor (Condition e) is satisfied, the tentative braking condition is not satisfied. Therefore, the CPU determines “No” in Step 1070, and directly proceeds to Step 1095 to temporarily terminate the processes of this routine. That is, the automatic braking control is not executed in this case.

When the tentative braking condition is satisfied in a state in which the maximum braking condition is not satisfied, the CPU determines “No” in Step 1055, determines “Yes” in Step 1070, and sequentially executes the following processes of Step 1075 to Step 1092. Then, the CPU proceeds to Step 1095.

Step 1075: The CPU acquires a tentative deceleration Aw based on Expression (5a).

Step 1080: The CPU sets a value of a target deceleration Atg to the tentative deceleration Aw.

Step 1085: The CPU reports the tentative braking control. Specifically, the CPU causes the display 33 to display a symbol indicating execution of the tentative braking control until a predetermined period has elapsed. In addition, the CPU causes the loudspeaker 34 to reproduce an alert sound indicating the execution of the tentative braking control until the predetermined period has elapsed.

Step 1090: The CPU transmits a braking force control request including the target deceleration Atg to the braking control ECU 23.

Step 1092: The CPU transmits, to the drive control ECU 22, a driving force control request in which the value of a target driving torque Ftg is set to “0”.

As a result, the driver's vehicle 10 is controlled so that the deceleration of the driver's vehicle 10 is equal to the tentative deceleration Aw. That is, the tentative braking control is started. When a turning operation for avoiding collision with the passing-region target is not started or the crossing target does not decelerate, the tentative braking control is executed in a period before the maximum braking condition is satisfied.

When the maximum braking condition is satisfied, the CPU determines “Yes” in Step 1055, and proceeds to Step 1060. The CPU sets the value of the target deceleration Atg to the maximum deceleration Amx. Subsequently, the CPU proceeds to Step 1065, and reports the maximum braking control. More specifically, the CPU causes the display 33 to display a symbol indicating execution of the maximum braking control until a predetermined period has elapsed. In addition, the CPU causes the loudspeaker 34 to reproduce an alert sound indicating the execution of the maximum braking control until the predetermined period has elapsed.

The CPU proceeds to Step 1090. In this case, the maximum braking control is started instead of the tentative braking control until the driver's vehicle 10 is stopped.

As described above, when the type of the crossing target is “other vehicle”, the ECU 21 determines the target braking necessary timing based on the target deceleration At. When the type of the crossing target is “pedestrian”, the ECU 21 determines the target braking necessary timing based on the distance threshold Lth. Therefore, the assistance apparatus can avoid collision with the crossing target, and can avoid the occurrence of unnecessary strong braking.

Although the driving assistance apparatus according to the embodiment of the present disclosure is described above, the present disclosure is not limited to the embodiment, and various modifications may be made without departing from the spirit of the present disclosure. For example, in this embodiment, the types of the crossing target that triggers the second braking control are “other vehicle” and “pedestrian”. The types of the crossing target that triggers the second braking control may differ from those types.

For example, the types of the crossing target that triggers the second braking control may include “ordinary-sized automobile”, “motorcycle”, and “large-sized vehicle” in place of “other vehicle”. In this case, the values of the target deceleration At to be applied to those types may differ from each other.

In this embodiment, when the type of the crossing target is “pedestrian”, the target braking necessary timing is the timing when the transverse target distance Dtx (that is, the distance in the X-axis direction between the crossing target and the right end or the left end of the driver's vehicle 10) is equal to the distance threshold Lth. A timing when a distance between the crossing target and the Y axis (that is, a central axis of the driver's vehicle 10 in the vehicle width direction) is equal to a predetermined threshold may be acquired as the target braking necessary timing.

The ECU 21 according to this embodiment acquires the tentative deceleration Aw based on Expression (5a). More specifically, the pressure increasing rate of the brake oil in the brake mechanism 45 is not taken into consideration when acquiring the tentative deceleration Aw. In other words, a period from a timing when the braking control ECU 23 starts to control the brake mechanism 45 to a timing when the braking force Bf is equal to a desired value is not taken into consideration. The ECU 21 may take the pressure increasing rate of the brake oil into consideration when acquiring the tentative deceleration Aw. For example, the ECU 21 may take an increase amount of the braking force Bf per unit time (that is, the pressure increasing rate of the brake oil) into consideration when acquiring the traveling distance Ds1 and the traveling distance Ds2.

The ECU 21 according to this embodiment determines whether the maximum braking condition and the tentative braking condition are satisfied based on the longitudinal target distances Dty of the passing-region target and the crossing target. For example, when the longitudinal target distance Dty of the crossing target is equal to or smaller than “distance obtained by adding distance margin Lm to longitudinal target braking distance Lty”, the ECU 21 determines that (Condition b) is satisfied. The ECU 21 may determine whether the maximum braking condition and the tentative braking condition are satisfied based on an elapse of time. For example, the ECU 21 may acquire a period to the time t1 at a certain timing (for example, the time t0 in FIG. 7) (that is, a difference between the time t1 and the time t0), and determine that (Condition b) is satisfied when the time t1 has arrived while the vehicle speed Vs and the target speed Vt remain unchanged.

The CPU of the ECU 21 takes the time margin Tm into consideration when determining the timings to start the tentative braking control and the maximum braking control. The process in which the time margin Tm is taken into consideration may be omitted. For example, the ECU 21 may start the maximum braking control at the maximum braking start necessary timing or the target braking necessary timing.

The ECU 21 may acquire (calculate) the braking start time Ti by substituting the longitudinal target speed Vty into Expression (2) in place of the vehicle speed Vs.

The maximum deceleration Amx according to this embodiment is a fixed value. The maximum deceleration Amx may be a variable. For example, the ECU 21 may acquire (estimate) a coefficient of friction between a road surface and each wheel of the driver's vehicle 10 by a related-art method, and set the maximum deceleration Amx to a larger value as the acquired coefficient of friction increases.

The ECU 21 according to this embodiment acquires the intersecting angle θi based on the longitudinal target speed Vty and the transverse target speed Vtx (see Expression (6c)), and acquires the transverse target braking distance Ltx based on the intersecting angle θi (see Expression (9)). In other words, the ECU 21 acquires the crossing target passing region as a linear region. The ECU 21 may acquire the crossing target passing region as a linear or arcuate region based on change amounts of the longitudinal target speed Vty and the transverse target speed Vtx per unit time, and acquire the transverse target braking distance Ltx based on the acquired crossing target passing region. Further, the ECU 21 may acquire the driver's vehicle passing region as a linear or arcuate region based on the steered angle θs, and acquire the transverse target braking distance Ltx based on the acquired driver's vehicle passing region.

The assistance apparatus according to this embodiment includes the front camera 31 as the sensor configured to detect a three-dimensional target (target detecting device). The assistance apparatus may include a millimeter wave radar device or a Light Detection and Ranging (LIDAR) device as the target detecting device in place of the front camera 31 or in addition to the front camera 31.

The functions implemented by the ECU 21 may be implemented by a plurality of ECUs. For example, the processes for detecting a three-dimensional target and acquiring information related to the three-dimensional target (that is, the longitudinal target distance Dty and the transverse target distance Dtx) may be implemented by an ECU mounted on the front camera 31.

What is claimed is:

1. A driving assistance apparatus comprising:
a target detecting device configured to detect a target approaching a vehicle passing region to cross the vehicle passing region, the vehicle passing region being a region where a vehicle is expected to travel;
a braking device configured to generate a braking force in the vehicle; and
a controller configured to control the braking device, wherein
the controller is configured to
identify the target as a crossing target and control the braking device to decelerate the vehicle at a first deceleration from a first timing before an expected collision timing that the vehicle and the crossing target are expected to collide with each other, when the vehicle keeps a current vehicle speed, the target keeps a current target speed, and the vehicle and the target are expected to collide with each other in an intersecting region where the vehicle passing region and a target passing region overlap each other, the target passing region being a region where the target is expected to pass, and
control the braking device to decelerate the vehicle at a second deceleration from a second timing when the crossing target is still present at the second timing immediately before a third timing, the third timing being a timing succeeding the first timing, defined such that the vehicle is being decelerated at the first deceleration, and defined such that the vehicle is not stoppable at a position immediately before entering the intersecting region when the vehicle starts to decelerate from the third timing at the second deceleration having an absolute value larger than an absolute value of the first deceleration.

2. The driving assistance apparatus according to claim 1, wherein:
the controller is configured to acquire, as the second timing, a target braking necessary timing immediately before a fourth timing;
the fourth timing is defined such that the crossing target starts to decelerate at a predetermined expected target deceleration; and
the fourth timing is defined such that the crossing target is not stoppable at a position immediately before entering the intersecting region when the crossing target continues to decelerate at the expected target deceleration.

3. The driving assistance apparatus according to claim 2, wherein:
the controller is configured to control the braking device to decelerate the vehicle at the second deceleration from a high-G braking start timing without decelerating the vehicle at the first deceleration from the first timing, when the target braking necessary timing is predicted to arrive before the high-G braking start timing;
the high-G braking start timing is a timing immediately before a fifth timing that the vehicle starts to decelerate at the second deceleration;
the fifth timing is a timing defined such that the vehicle continues to decelerate at the second deceleration and the vehicle is not stoppable at a position immediately before entering the intersecting region.

4. The driving assistance apparatus according to claim 2, wherein the controller is configured to:
acquire a type of the crossing target; and
change the expected target deceleration depending on the acquired type.

5. The driving assistance apparatus according to claim 1, wherein the controller is configured to:
acquire a type of the crossing target; and
acquire, as the second timing, a timing that a distance between a pedestrian and the vehicle passing region is smaller than a predetermined distance threshold when the acquired type is the pedestrian.
